(19) United States
(12) Patent Application Publication
(10) Pub. No.: US 2014/0171085 A1
(43) Pub. Date: Jun. 19, 2014

(54) METHOD AND APPARATUS FOR HANDOVER PROCESSING

(71) Applicant: Haitao Li, Beijing (CN)

(72) Inventor: Haitao Li, Beijing (CN)

(73) Assignee: Nokia Corporation, Espoo (FI)

(21) Appl. No.: 14/233,376

(22) PCT Filed: Jul. 26, 2011
(86) PCT No.: PCT/CN2011/077616

§ 371 Date: Jan. 16, 2014

(51) Int. Cl. H04W 36/00

(52) U.S. Cl. CPC H04W 36/0061
USPC 455/436

(57) ABSTRACT

In accordance with an example embodiment of the present invention, there is provided an apparatus such as a user equipment configured to receive a handover command from a network element, such as a base station, and to determine identities of a plurality of cells from the handover command, and to consider the cell identities as identities of cells prepared to accept the apparatus. The apparatus may be further configured to use one of the cells for re-establishment following a handover failure.

### TECHNICAL FIELD

The present application relates generally to handovers and handover reliability in the context of wireless communication.

### BACKGROUND

Cellular communication networks, or cellular networks, comprise a large number of cells which are integrated together to form the network. A cellular network may span an entire country, in which case it may be referred to as a countrywide network. Cellular networks provide large-area roaming, allowing users to move about large areas with continuous access to the network. This makes it possible, for example, for a consumer to remain connected to a single voice call or data connection while traversing a country by train or car.

Networks with smaller geographical reach may be referred to as local networks. Whereas local networks may not be able to offer the geographic reach of cellular networks, especially nationwide cellular networks, they may offer a high datarate in a more limited area where large numbers of customers need connectivity. One example of a local network is a wireless local area network, WLAN, access point. Another example is a femtocell, by which it is meant a cellular cell of limited range.

Femtocells, or in general cells with limited range, may be deployed for various reasons. Historically smaller cells have been used to increase network capacity by allowing frequencies to be re-used to a higher degree over a given geographic area. A large cell allows for a set of frequencies to be used only once, which limits capacity. By splitting a large cell into smaller ones, the same set of frequencies may be used more than once, allowing a network operator to serve a larger number of subscribers in the same area using the same frequency band. Other names for smaller cells include picocells which may be seen as larger than femtocells, and microcells which in turn may be seen as larger than picocells.

Smaller cells may also be used where transmission power limits don't allow installing a cell of larger radius. This is due to the fact that a base station serving a large cell must transmit to the edge of the large cell, which is farther away than an edge of a smaller cell.

Another reason for using smaller cells is to allow a limited subset of subscribers to access an alternative cell, which may be comprised in a larger network that is open to a larger set of subscribers. Such a cell may be known as a closed subscriber group, CSG, cell. To define a CSG cell, a corresponding set of subscribers that have access to the CSG cell may be defined. A CSG cell may be considered to be a special type of femto-pico- or microcell, for example.

### SUMMARY

Various aspects of examples of the invention are set out in the claims.

According to a first aspect of the present invention, there is provided an apparatus comprising a receiver configured to receive a handover command from a network element and at least one processing core configured to determine identities of a plurality of cells from the handover command, the at least one processing core being further configured to consider the cell identities as identities of cells prepared to accept the apparatus.

According to a second aspect of the present invention, there is provided a method comprising receiving a handover command from a network element, determining identities of a plurality of cells from the handover command, and onsidering the cell identities as identities of cells prepared to accept the apparatus.

According to a third aspect of the present invention, there is provided an apparatus, comprising at least one processor, at least one memory including computer program code, the at least one memory and the computer program code configured to, with the at least one processor, cause the apparatus to at least prepare a plurality of base stations for handover for a mobile device and transmit a handover command toward the mobile device, the handover command comprising identities of a plurality of cells associated with the plurality of base stations.

According to a fourth aspect of the present invention, there is provided a method comprising preparing a plurality of base stations for handover for a mobile device and transmitting a handover command toward the mobile device, the handover command comprising identities of a plurality of cells associated with the plurality of base stations.

According to further aspects of the invention, there are provided computer programs and computer-readable storage media configured to cause methods falling within the scope of the invention to be performed, when run.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system capable of supporting embodiments of the invention;

FIG. 2 illustrates an example apparatus 201 capable of supporting embodiments of the present invention.

FIG. 3 is a flowchart illustrating an example method according to some embodiments of the invention.

FIG. 4 illustrates signaling related to some embodiments of the invention.

### DETAILED DESCRIPTION OF THE DRAWINGS

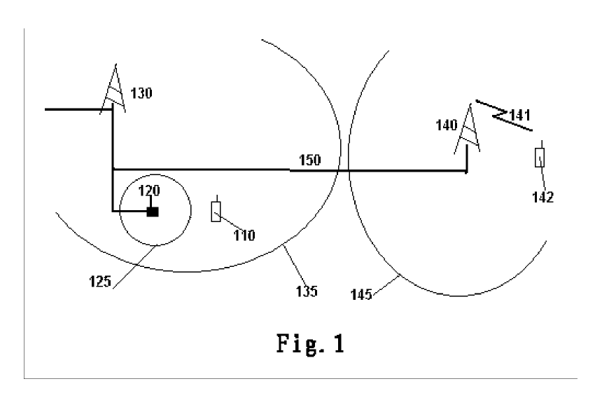

An example embodiment of the present invention and its potential advantages are understood by referring to FIGS. 1 through 4 of the drawings.

FIG. 1 illustrates an example system capable of supporting embodiments of the invention. The system comprises mobile 110, which may be a cellular telephone, personal digital assistant, PDA, cellular telephone, tablet computer or another kind of device, for example. Base stations 130 and 140 may be configured to operate according to at least one cellular standard, such as global system for mobile communication, GSM, wideband code division multiple access, WCDMA or long term evolution, LTE, for example. Base station 120 may be considered to control a cell of its own. Base stations 130 and 140 may be configured to communicate using a pre-defined band of licensed spectrum, which has been allocated by authorities for cellular communication. Base station 120 may operate according to wireless local area network, WLAN, or worldwide interoperability for microwave access, WiMAX, technologies, for example, or according to a cellular standard like cells 135 and 145, which are controlled by base stations 130 and 140, respectively. Base station 120 may be configured to control a CSG cell 125. CSG cell 125 may be considered to be a smaller cell when compared to cells 135 and 145. CSG cell 125 may operate using the same technology as cells 135 and 145, and CSG cell 125 may be comprised in the same network as cells 135 and 145. In some embodiments, base station 120 is a mobile device.

Mobiles may roam from location to location, and depending on measurements of signal strength between mobile and base station, mobiles may change from communicating with a first base station, such as base station 130, to communicating with another base station, such as base station 140. Such a change may be known as a handover. In one form of handover, known as soft handover, a mobile may change from communicating with base station 130 only to communicating with base station 130 and base station 140. A set of base stations with which a mobile communicates simultaneously may be known as an active set.

CSG cell 125 may be configured to provide additional coverage for a subset of users, such as premium users or emergency services users. CSG cell 125 may be configured to provide services that are not available in other cells, such as cells 135 and 145. CSG cell 125 may provide a location estimate to users allowed to attach to it since CSG cell 125 may be a relatively small cell. Calls and connections from CSG cell 125 may be given preferential access to taxi centres, service numbers and/or intranet/extranet accesses, for example.

Network design and optimization aim to facilitate handovers between cells so that they rarely fail. It may nonetheless occur that a handover fails. A handover to a small cell may be more difficult to conclude successfully, for example, since a mobile that moves fast may exit the coverage area or enter an area of faded signal within the cell. Other possible causes for handover failure include errors in handover timing, radio channel fluctuation and access rights denial. Therefore networks with heterogeneous cells, such as networks comprising a mix of larger and smaller cells, may benefit from optimized handover procedures.

Mobile 110 may be capable of communicating with at least one cellular protocol used by base stations 120, 130 and/or 140. FIG. 1 illustrates further mobile 142 in wireless communication with base station 140. Wireless link 141 interconnects further mobile 142 and base station 140. Wireless link 141 may comprise a downlink for conveying information from base station 140 to further mobile 142. Wireless link 141 may comprise an uplink for conveying information from further mobile 142 to base station 140. Wireless link 141 may conform to a cellular communication standard, for example. Wireless link 141 may be based on GSM, WCDMA, LTE or another standard. Wireless link 141 may be based on orthogonal frequency division multiple access, OFDMA, code division multiple access, CDMA, time divisions multiple access, TDMA, or a combination of these, for example. Wireless links between mobiles and base stations 130 and 120 may be substantially similar to wireless link 141. Alternatively a network comprising base stations 120, 130 and 140 may be multi-standard in the sense that base stations comprised therein don't all conform to the same radio access technology, RAT.

Base stations 120, 130 and 140 are in the example system of FIG. 1 interconnected by a backbone network 150. Backbone network 150 is further connected to other parts of the cellular network in which base stations 120, 130 and 140 are comprised. The cellular network may comprise in addition to base stations various nodes such as switches, mobility management entities, MMEs, serving gateways, SGWs, base station controllers and the like, depending on the embodiment and type of network.

When mobile 110 roams within the coverage area of the network, a handover may be triggered, for example responsive to measurement results sent to the network by mobile 110. From these measurement results the network may be capable of determining, for example, that mobile 110 is moving toward a cell edge. The measurements may comprise mobile 110 measuring received power from channels broadcast by base stations. A base station currently serving mobile 110, known as a source base station, may conduct preparations for a handover of mobile 110 to a new cell, known as the target cell. The preparations may comprise selecting an optimal target cell and causing a target base station to receive information on mobile 110. The target cell is controlled by the target base station, which may control also cells other than the target cell. The source base station can transmit information on mobile 110 directly to the target base station, or alternatively or additionally the source base station may send a signal to a further network element to cause the further network element to transmit information on mobile 110 to the target base station.

Information concerning mobile 110 that is sent to the target base station may be known as a context of mobile 110. The context may comprise history information on cells mobile 110 has been attached to previously, possibly including cells from more than one network and radio access technology. The context may alternatively or further comprise at least some of information on active radio bearers, capability information of mobile 110, and a radio resource configuration of mobile 110, for example.

The source base station may cause more than one base station to be furnished with a context of mobile 110. In other words, the target base station may not be the only base station to receive the context during the handover preparation phase.

After preparation is complete, the source base station may send a handover command signaling message to mobile 110. The handover command instructs mobile 110 to initiate procedures to associate itself with the target cell, which is identified in the handover command The target cell may be identified by at least one of a physical cell identity, PCI, a cell global identity or other suitable identifier that mobile 110 is capable of associating with the target cell. One option for identifying the target cell in the handover command is to identify a scrambling or channelization code used by the target cell. A yet further option is to identify a frequency or frequencies used by the target cell. In some embodiments the handover command identifies the target cell using at least one frequency and at least one identity of the target cell.

Responsive to receiving the handover command, mobile 110 may be configured to attempt handover to the target cell. If handover is successful, mobile 110 may continue communicating via the target cell. In case handover is unsuccessful, however, mobile 110 may be configured to transition to an idle mode and lose connections, such as voice calls, which were active when the failed handover was initiated. Alternatively, mobile 110 may attempt a connection re-establishment procedure with the target cell or another cell. In some embodiments, as a result of a successful re-establishment, mobile 110 may recover from the handover failure while retaining connections that were active at the start of the handover. With successful re-establishment mobile 110, or a user of mobile 110, doesn't need to re-initiate and re-negotiate connections that were active at the start of the handover that failed. In other embodiments, mobile 110 may simply remain in a connected state due to successful re-establishment, rather than transition into an idle state.

For re-establishment to conclude swiftly and successfully it may be beneficial for mobile 110 to attempt re-establishment to a cell controlled by a base station that has a context of mobile 110. Since the context may describe the connection state of mobile 110 at the start of the attempted handover, having it in the base station that re-establishement is attempted to improves the chances that connections are re-established before they fail, for example due to timeout.

In order to prepare mobile 110 for the eventuality of handover failure, the network may include in the handover command information concerning cells or base stations that have access to context information relating to mobile 110. For example, the handover command transmitted to mobile 110 may comprise an identity of the target cell and a list of cells other than the target cell, wherein the cells other than the target cell are controlled by base stations that have been prepared for handover. The cells other than the target cell that have been prepared for handover may thus store or have access to a context of mobile 110, and may thus be good candidates for connection re-establishment should handover to the target cell fail. The handover command may comprise a single list of cells with the target cell being first in the list, or the information may be arranged in the handover command in another appropriate way so that mobile 110 can understand it and act on it. The cells other than the target cell may be identified using a similar format as is used to identify the target cell. Instead of or additionally to cells, the handover command may identify base stations; for example a target base station and other base stations that store a context of mobile 110. A cell that is prepared but is not the target cell may be controlled by the target base station. This is since the target base station has been furnished with the context during the handover preparation phase, and the target base station may control more than one cell.

In general in some embodiments an apparatus such as, for example, mobile 110 or an integrated chip comprised in mobile 110, may be configured to receive a handover command from a network node, such as for example a source base station. The source base station may be comprised in a WCDMA or LTE network, for example. The receiving of the handover command may be considered to occur at an antenna of mobile 110, or alternatively at a pin of an integrated chip inside mobile 110. The apparatus may be configured to determine identities of a plurality of cells from the handover command, such as identities of the target cell and other prepared cells. The determining may take place in at least one processing core comprised in an integrated chip comprised in mobile 110, for example. The at least one processing core may be configured to cause the apparatus to consider the cells as prepared to accept the apparatus. For example, the apparatus may consider the cells as candidates for connection re-establishment. Alternatively to determining identities of cells, the apparatus may be configured to determine identities of base stations from the handover command

In some embodiments, the at least one processing core is configured to cause the apparatus to attempt handover to the target cell. In connection with starting handover procedures, the apparatus may be configured to start a timer to control the length of the handover. Starting a handover procedure may comprise transmitting at least one signaling message from the apparatus to the source base station, the target base station, or both. The at least one signaling message may be configured to cause the network to begin processing the handover.

In some embodiments, the at least one processing core is configured to cause the apparatus to select a cell other than the target cell for re-establishment of connectivity. The apparatus may determine from measurements which cells are reachable and select one that is both reachable and one of the cells an identity of which was determined from the handover command Alternatively, the at least one processing core may be configured to cause the apparatus to select a specific base station other than the target base station for re-establishment of connectivity.

In some embodiments, the apparatus is configured to initiate re-establishment responsive to determining that handover has failed. The apparatus may determine that handover has failed by observing that a timer started at the beginning of the handover expires before the handover has been successfully completed and acknowledged, or the apparatus may receive a signaling message informing the apparatus that the handover has failed. Such a signaling message may be transmitted via a broadcast channel of the source base station or the target base station, for example. An advantage of a signaling message may be that the apparatus is capable of determining that the handover has failed sooner than from an expired timer.

In some embodiments, the apparatus is configured to initiate re-establishment by transmitting a re-establishment request signaling message to a cell other than the target cell, wherein an identity of the cell to which the request is transmitted is determined from the handover command. The re-establishment request may comprise a reason for re-establishment, which may be handover failure, for example.

In some embodiments, the apparatus is configured to include in the re-establishment request signaling message an identity of the source cell, which may be an identity associated with the source base station.

In general in some embodiments an apparatus such as, for example, a source base station, may be configured to prepare a plurality of base stations to receive a mobile, such as mobile 110, currently attached to the apparatus. Preparing may comprise transmitting at least part of a context of the mobile to the plurality of base stations, or alternatively or in addition causing another node to transmit at least part of the context of the mobile to the plurality of base stations. The apparatus may be further configured to transmit a handover command to the mobile, the handover command being configured to allow the mobile to identify, or determine the identities of, the plurality of base stations or cells controlled by the plurality of base stations. One of the plurality of base stations or cells may be identified in the handover command as a target base station or target cell in the sense that the mobile is instructed primarily to attach to it.

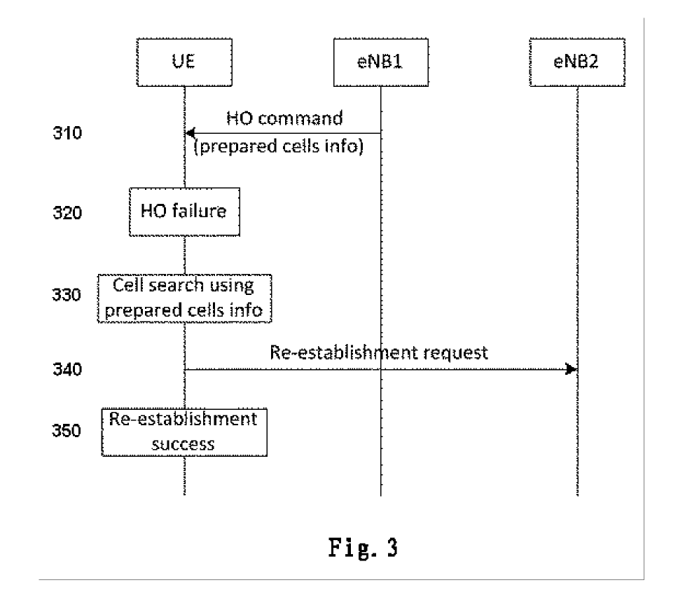

FIG. 3 is a flowchart illustrating an example method according to some embodiments of the invention. In phase 310 a source base station, in this illustration of an LTE system marked as eNB1, transmits to a mobile, illustrated as UE, a handover command comprising information on prepared cells. The handover command may be transmitted on a data or control channel, as a standalone signaling message or embedded in another signaling or data packet or message. The handover command may explicitly or implicitly identify in the handover command a specific cell as a target cell, or a specific base station as target base station, for handover. The prepared cells may have been prepared prior to phase 310. Preparing may comprise causing the cells to receive at least a part of a context of the user equipment, UE. Alternatively eNB1 may begin preparing the cells substantially at the same time as transmission of the handover command, for example in case the handover command comprises an indication as to when the UE is instructed to begin handover. If there is time remaining before the handover, eNB1 may be able to prepare the cells before the UE initiates the handover from its side, or at least before handover timers expire to indicate the handover has failed.

In phase 320 the UE determines that the handover instructed in the handover command of phase 310 has failed, for example by observing that a handover timer expires before the handover is successfully completed. In phase 330, responsive to determining the handover fails, the UE may determine candidate cells for connection re-establishment. For example, the UE may search for cells or base stations that are feasible from a radio channel point of view, in other words the UE may determine which cells or base stations can be reliably communicated with from its present location. The UE may then select, for example, the cell or base station for re-establishement that is in the list of prepared cells or base stations received in the handover command, and has the most favourable radio channel characteristics as determined from search measurements.

In phase 340 the UE may transmit a re-establishment request message to the cell or base station selected in phase 330. In FIG. 3 this entity is illustrated as eNB2. In connection with transmitting the re-establishment request, UE may start a timer. As eNB2 has a copy of at least part of a context of UE, the re-establishment is expected to succeed, phase 350. Alternatively, for example if the re-establishment isn't successfully concluded before the timer expires in the UE, re-establishment may fail and the UE may transition to an idle state, which is not illustrated in FIG. 3.

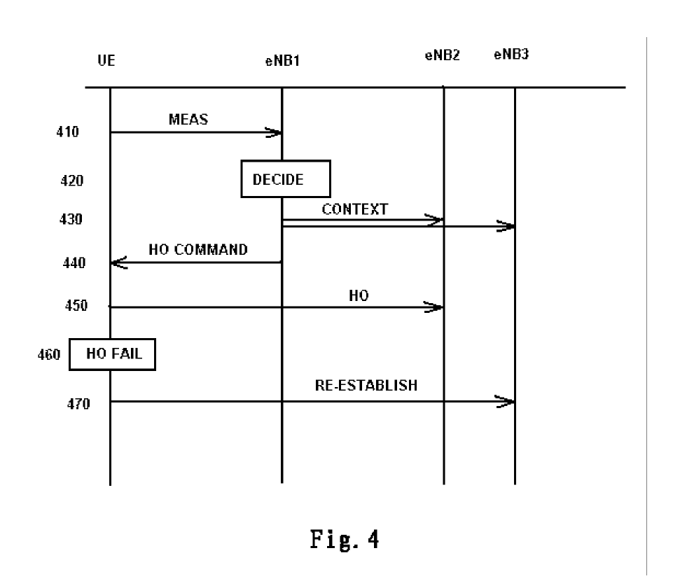

FIG. 4 illustrates signaling related to some embodiments of the invention. In phase 410 a UE transmits to a base station at least one measurement report comprising information relating to how strongly the UE perceives signals from base stations, or eNBs, in its vicinity. The UE may measure, for example, broadcast beacon channels that the base stations, illustrated as eNB for in FIG. 4, transmit for mobiles to facilitate roaming procedures. eNB is a notation referring to evolved node-B, a base station in the LTE standard.

Based at least in part on the measurement data from UE received in phase 410, the serving, or source, eNB may decide or participate in deciding to hand over the UE to another eNB, namely eNB2. Responsive to the deciding, eNB1 may transmit at least part of a UE context to eNB2 and eNB3, phase 430. eNB3 is another base station that based on the measurement data is or is expected to be reachable to the UE. Alternatively, eNB1 may cause the at least part of the context to be transmitted to eNB2 and eNB3 instead of transmitting it itself. eNB2 and eNB3 may acknowledge to eNB1 receipt of the context, which may trigger eNB1 to transmit to the UE a handover command, phase 440. The handover command may comprise indications allowing the UE to consider eNB2 as the target base station and eNB3 as a further base station prepared to accept the UE. Alternatively, the handover command may comprise indications allowing the UE to consider a cell controlled by eNB2 as the target cell and other cells controlled by eNB2 and/or eNB3 as further cells prepared to accept the UE. In the illustrated example, eNB2 may control a relatively small CSG cell, for example, and eNB3 may control a non-CSG cell with a large cell size, such that geographically speaking the cell of eNB2 is embedded within the cell of eNB3.

In phase 450, responsive to receiving the handover command, the UE may be configured to transmit a signaling message to eNB2 to initiate handover from eNB1 to eNB2. In connection with this phase, the UE may be configured to start a timer to manage the handover. In phase 460 the UE may determine that the handover has failed, for example by receiving a signaling message informing the UE that the handover has failed or alternatively by observing that a timer started in phase 450 expires before the handover is successfully completed.

Responsive to determining handover failure, the UE may be configured to determine whether any of the other base stations or cells mentioned in the handover command are reachable. In the illustrated example, eNB3 or one of its cells was identified in the handover command as prepared to accept the UE, and the UE is within radio range of eNB3. The UE may determine that eNB3 is within range by measurements. Therefore, the UE may be configured to initiate a re-establishement procedure toward eNB3, or one of its cells, by transmitting to eNB3 a re-establishment signaling message, which may comprise, for example, a re-establishment reason and an identity of the source eNB, eNB1, or the source cell. Since eNB3 has been furnished with at least part of the UE context, it is expected that re-establishment will be successful without undue delays.

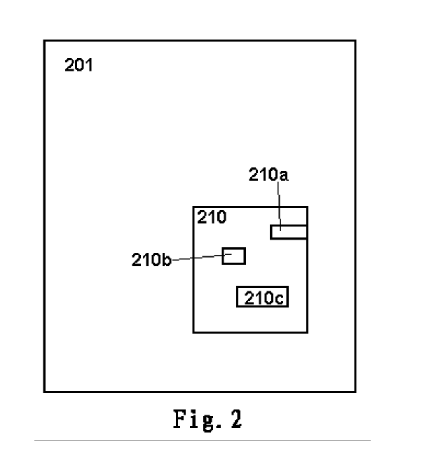

FIG. 2 illustrates an example apparatus 201 capable of supporting embodiments of the present invention. The apparatus may correspond to mobile 110, or base station 120, for example. The apparatus is a physically tangible object, for example a mobile telephone, personal digital assistant, data dongle or a similar device. The apparatus may comprise a control apparatus 210, for example a digital signal processor, DSP, processor, field-programmable gate array, FPGA, application-specific integrated circuit, ASIC, chipset or controller. The apparatus may further comprise a transmitter and/or a receiver 210a configured to enable the apparatus 201 to connect to other apparatuses. A combination of transmitter and receiver may be called a transceiver. The apparatus may comprise memory 210b configured to store information, for example configuration information. The memory may be solid-state memory, dynamic random access memory, DRAM, magnetic, holographic or other kind of memory. The apparatus may comprise logic circuitry 210c configured to access the memory 210b and control the transmitter and/or a receiver 210a. The logic circuitry 210c may be implemented as software, hardware or a combination of software and hardware. The logic circuitry may comprise at least one processing core. The logic circuitry 210c may execute program code stored in memory 210b to control the functioning of the apparatus 201 and cause it to perform functions related to embodiments of the invention. The logic circuitry 210c may be configured to initiate functions in the apparatus 201, for example the sending of data units via the transmitter and/or a receiver 210a. The logic circuitry 210c may be control circuitry. The transmitter and/or a receiver 210a, memory 210b and/or logic circuitry 210c may comprise hardware and/or software elements comprised in the control apparatus 210. Memory 210b may be comprised in the control apparatus 210, be external to it or be both external and internal to the control apparatus 210 such that the memory is split to an external part and an internal part. If the apparatus 201 does not comprise a control apparatus 210 the transmitter and/or a receiver 210a, memory 210b and logic circuitry 210c may be comprised in the apparatus as hardware elements such as integrated circuits or other electronic components. The same applies if the apparatus 201 does comprise a control apparatus 210 but some, or all, of the transmitter and/or a receiver 210a, memory 210b and logic circuitry 210c are not comprised in the control apparatus 210. In embodiments where apparatus 201 is a mobile user equipment, apparatus 201 may comprise at least one antenna

Without in any way limiting the scope, interpretation, or application of the claims appearing below, a technical effect of one or more of the example embodiments disclosed herein is that a delay incurring from a handover failure is reduced in that re-establishment is attempted to a base station that is already prepared to receive the mobile. Another technical effect of one or more of the example embodiments disclosed herein is that the success rate of re-establishements may be increased. Another technical effect of one or more of the example embodiments disclosed herein is that users experience fewer connection interruptions, which provides for more reliable wireless communication.

Embodiments of the present invention may be implemented in software, hardware, application logic or a combination of software, hardware and application logic. The software, application logic and/or hardware may reside on memory 210b, the control apparatus 210 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims

1-20. (canceled)

21. An apparatus, comprising:
a receiver configured to receive a handover command from a network element;
at least one processing core configured to determine identities of a plurality of cells from the handover command;
the at least one processing core being further configured to consider the cell identities as identities of cells that are candidates for connection re-establishment for the apparatus.

22. An apparatus according to claim 21, wherein the at least one processing core is further configured to cause the apparatus to attempt handover to a target cell comprised in the plurality of cells.

23. An apparatus according to claim 22, wherein the least one processing core is further configured to cause the apparatus to re-establish connectivity to a first cell comprised in the plurality of cells, the first cell being other than the target cell.

24. An apparatus according to claim 23, wherein the least one processing core is configured to cause the apparatus to re-establish connectivity responsive to failure to handover to the target cell.

25. An apparatus according to claim 24, wherein re-establishing comprises transmitting a re-establishment request to the first cell, the re-establishment request comprising an indication of reason, the reason being handover failure.

26. An apparatus according to claim 25, wherein the re-establishment request also comprises a source cell identity associated with the network element.

27. An apparatus according to claim 21, wherein the apparatus comprises a mobile communication device, the apparatus further comprising an antenna coupled to the receiver and configured to provide signals to the at least one processing core.

28. A method, comprising:
receiving a handover command from a network element;
determining identities of a plurality of cells from the handover command;
considering the cell identities as identities of cells that are candidates for connection re-establishment for an apparatus.

29. A method according to claim 28, further comprising attempting handover to a target cell comprised in the plurality of cells.

30. A method according to claim 29, further comprising re-establishing connectivity to a first cell comprised in the plurality of cells, the first cell being other than the target cell.

31. A method according to claim 30, comprising re-establishing connectivity responsive to failure to handover to the target cell.

32. A method according to claim 31, wherein re-establishing comprises transmitting a re-establishment request to the first cell, the re-establishment request comprising an indication of reason, the reason being handover failure.

33. A method according to claim 32, wherein the re-establishment request also comprises a source cell identity associated with the network element.

34. An apparatus, comprising:
at least one processor; and
at least one memory including computer program code
the at least one memory and the computer program code configured to, with the at least one processor, cause the apparatus to perform at least the following:
prepare a plurality of base stations for handover for a mobile device;
transmit a handover command toward the mobile device, the handover command comprising identities of a plurality of cells associated with the plurality of base stations.

35. An apparatus according to claim 34, wherein preparing base stations comprises causing the base stations to be furnished with a context of the mobile device.

36. A method, comprising:
preparing a plurality of base stations for handover for a mobile device, and
transmitting a handover command toward the mobile device, the handover command comprising identities of a plurality of cells associated with the plurality of base stations.

37. A method according to claim 36, wherein preparing base stations comprises causing the base stations to be furnished with a context of the mobile device
